(19) United States
(12) Patent Application Publication
(10) Pub. No.: US 2003/0128193 A1
(43) Pub. Date: Jul. 10, 2003

(54) Touch control pen for PDA

(75) Inventors: Chao-Chi Huang, Taipei (TW); Ming-Chung Chiu, Keelung (TW)

Correspondence Address: Raymond Sun, Law Offices of Raymond Sun, 12420 Woodhall Way, Tustin, CA, 92782, US

(73) Assignee: Quarton Inc.

(21) Appl. No.: 10/137,099

(22) Filed: May 1, 2002

Related U.S. Application Data
(63) Continuation-in-part of application No. 10/039,696, filed on Jan. 4, 2002.

(51) Int. Cl. G09G 5/00

(52) U.S. Cl. 345/173

(57) ABSTRACT

A touch control pen for a PDA has a pen holder, and a light source coupled to the pen holder for generating light. Alternatively, the touch control pen has a pen holder, and an element that secures the pen holder to a portion of a PDA. The touch control pen also incorporates a writing implement.

### RELATED CASES

The present application is a continuation-in-part of application Ser. No. 10/039,696, filed Jan. 4, 2002, entitled “Touch Control Pen for PDA”, now pending, whose entire disclosure is incorporated by this reference as though fully set forth herein.

### BACKGROUND OF THE INVENTION

1. Field of the Invention

The present invention relates to touch control pens that are adapted for use with a personal digital assistant (PDA).

2. Description of the Prior Art

PDAs (personal digital assistant) have become increasingly popular in recent years. Its popularity can be attributed to a number of factors, including: (1) the fact that it can often function like a personal computer (PC), (2) the fact that it can be conveniently operated by using a touch control pen to touch and choose items on its screen, and (3) the fact that its small size is convenient for carrying about in a pocket, handbag, briefcase or other small carrying bag.

Unfortunately, since the screen of a PDA is constructed of a liquid crystal display (LCD), usage of the PDA in darker environments can be more difficult. For example, the LCD typically cannot illuminate itself, so it will be difficult for the user to view the screen. To remedy this problem, efforts have been made to install a backing light plate behind the LCD to provide the necessary illumination. However, the continuous use of a backing light plate consumes a large amount of power, which decreases the total amount of time that a user can use the PDA before the battery needs to be recharged.

Another drawback associated with PDAs is that the touch control pens that are usually provided with these PDAs are usually retained inside an elongate groove of the housing of the PDA. These pens are not properly secured inside the groove and can be easily dislodged and lost.

Thus, there remains a need for a PDA that addresses the problems described above.

### SUMMARY OF THE DISCLOSURE

It is an object of the present invention to provide a PDA which can provide sufficient illumination of the screen in dark environments.

It is another object of the present invention to provide a PDA which can provide sufficient illumination of the screen in dark environments without requiring the use of excess power.

It is yet another object of the present invention to provide a touch control pen that can be used with the PDA, with the touch control pen capable of providing selective illumination for the screen of the PDA.

It is yet another object of the present invention to provide a touch control pen that can be securely retained inside the housing of a PDA.

It is yet another object of the present invention to provide a touch control pen that incorporates a writing implement.

To achieve the above objectives, the present invention provides, in one embodiment, a touch control pen for a PDA, the touch control pen having a pen holder, with a light source coupled to the pen holder for generating light. In another embodiment, the touch control pen has means for securing the pen holder to a portion of a PDA. In yet another embodiment, the touch control pen has a writing implement retained inside the pen holder.

### BRIEF DESCRIPTION OF THE DRAWINGS

FIG. 1 is an exploded perspective view of a touch control pen according to one embodiment of the present invention.

FIG. 2 is a perspective view of the touch control pen of FIG. 1 after it has been assembled.

FIG. 3 is an exploded perspective view of a light emitting diode of the present invention joined with a pen head.

FIG. 4 is an exploded perspective view of a touch control pen according to another embodiment of the present invention shown incorporating the light emitting diode and pen head of FIG. 3.

FIG. 5 is a perspective view of the touch control pen of FIG. 4 after it has been assembled.

FIG. 6 illustrates the touch control pen of FIG. 1 in use with a PDA.

FIG. 7 illustrates the touch control pen of FIG. 1 stored inside a PDA.

FIG. 8 is a perspective view of a touch control pen according to another embodiment of the present invention.

FIG. 9 is an exploded perspective view of the touch control pen of FIG. 8.

FIG. 10 is a cross-sectional view of the touch control pen of FIG. 8.

FIG. 11 is an exploded perspective view of a touch control pen according to yet another embodiment of the present invention incorporating a writing implement.

FIG. 12 is a perspective view of the touch control pen of FIG. 11 after it has been assembled.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

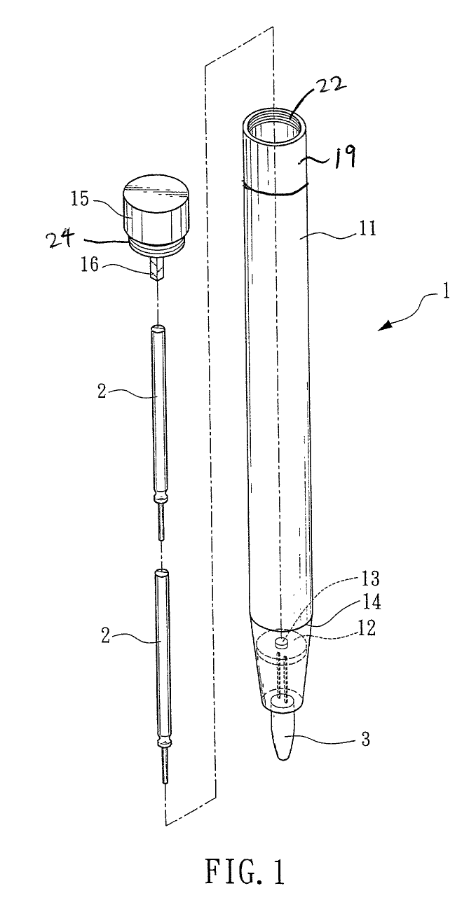

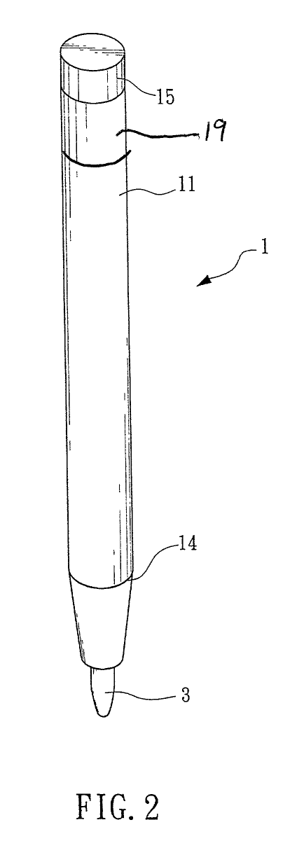

FIGS. 1 and 2 illustrate a touch control pen 1 according to one embodiment of the present invention. The touch control pen 1 has three major parts: a generally cylindrical pen holder 11, a pen lid 15, and a light emitting diode (LED) 3. The light emitting diode 3 is provided at the forward end of the pen holder 11. A circuit unit 12, which can be embodied in the form of a circuit plate or printed circuit board (PCB), is coupled to the light emitting diode 3 at the forward end of the pen holder 11, and houses the necessary electronics (which are well-known in the art) for operating the light emitting diode 3 of the touch control pen 1. An electrical contact joint 13 is positioned at about the center of the circuit unit 12, and is adapted to be electrically coupled to a battery 2 so that the battery 2 can supply the power needed to drive the light emitting diode 3. The battery 2 can be a conventional lithium battery, such as the National BR435 having a voltage of 3V. At least one battery 2 is needed, although two or more such batteries 2 can be provided, as illustrated in FIG. 1. The batteries 2 are positioned inside the hollow interior of the pen holder 11, and the pen lid 15 is then screwed to the rear end of the pen holder 11 by threadably engaging screws 22 and 24 provided in the interior of the pen holder 11 and an outer surface of the pen lid 15, respectively. The manner of connecting the pen lid 15 and the pen holder 11 is not limited to a screw or threaded connection, and other connection mechanisms (e.g., pressing, snap-fit, riveting, or glue, etc.) can also be utilized. An insulation piece 16 extends from the bottom of the pen lid 15 and is adapted to be abutted against the rear-most battery 2 to assure that the batteries 2 are pushed securely against the joint 13 to form a completed electrical circuit. A switch 14 can be provided on the pen holder 11 to turn the light emitting diode 3 ON or OFF by controlling the circuit unit 12. The switch 14 can be embodied in the form of a conventional rotary switch 14, where the light emitting diode 3 can be turned ON or OFF by rotating the upper and lower portions of the pen holder 11 about the switch 14. As an alternative, a push button switch (not shown in the drawings) can be positioned at any location on the penholder 11 to achieve the same function as the rotary switch 14. FIG. 2 illustrates the touch control pen 1 after it has been assembled. In this embodiment, the light emitting diode 3 functions as both a light source and as a pen stylus for touching the screen of the PDA, and can be made of any material that is used for standard light-emitting diodes.

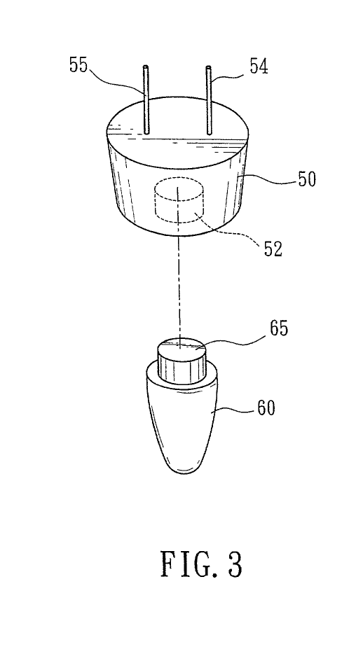

FIG. 3 illustrates another embodiment of the light emitting diode according to the present invention, in which it incorporates a separate non-LED pen head or stylus. The light emitting diode 50 in FIG. 3 has a frusto-conical configuration, and has a recessed groove 52 provided on one side thereof. Two electrical conduction legs 54 are provided (e.g., by welding) at the other side of the diode 50 (i.e., opposite the recessed groove 52) for making an electrical connection. The stylus 60 has a generally conical configuration having a protrusion block 65 extending at a rear end of the stylus 60. The block 65 corresponds with, and is adapted to be secured inside, the recessed groove 52 of the light emitting diode 50. The block 65 can be secured inside the groove 52 by insertion, glue, thermal melting, etc. The light emitting diode 50 can be made of the same or similar material as the light emitting diode 3 described above, and functions to emit light. The stylus 60 does not emit light, and functions solely as a stylus or tip of the touch control pen. In this regard, the material of the stylus 60 can be different from that of the light emitting diode 50, and can include materials such as plastic, steel, plastic, alloy, etc. This different material provides the stylus 60 with a smoother touch as the stylus 60 contacts selected points on the screen of the PDA.

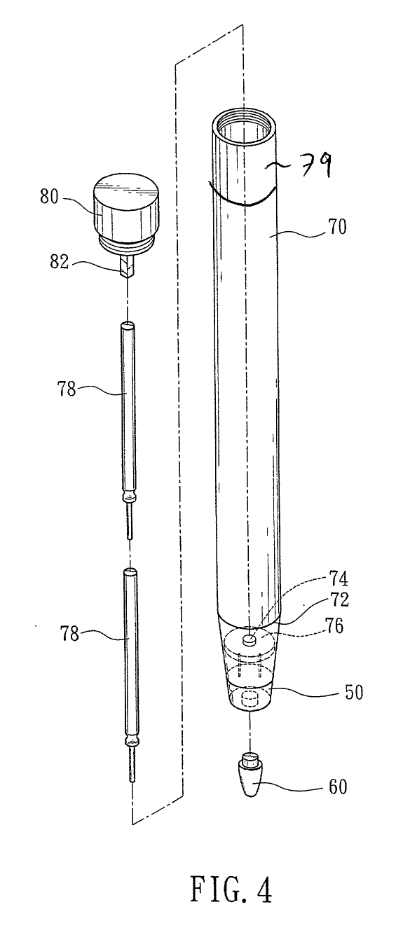

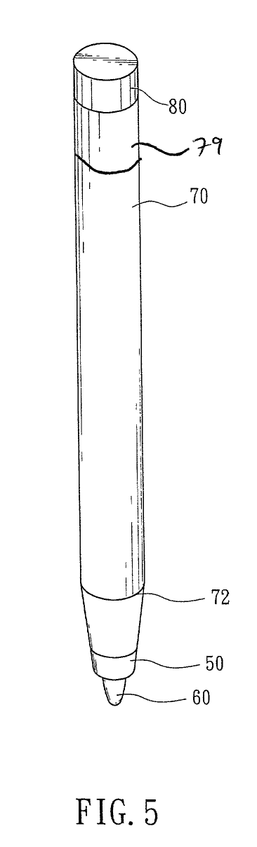

FIGS. 4 and 5 illustrate a touch control pen that incorporates the light emitting diode 50 and the stylus 60 described in FIG. 3. The light emitting diode 50 is secured to the forward end of the pen holder 70 by connecting the legs 54 and 55 with the circuit unit 76, which can be a PCB or circuit plate. The pen holder 70, the switch 72, the joint 74, the circuit unit 76, the batteries 78, the pen lid 80 and the insulation piece 82 can be the same as, and can operate in the same manner as, the pen holder 11, the switch 14, the joint 13, the circuit unit 12, the batteries 2, the pen lid 15 and the insulation piece 16, respectively, in FIGS. 1 and 2, and shall not be described in greater detail herein. FIG. 5 illustrates the touch control pen of FIG. 4 after it has been assembled.

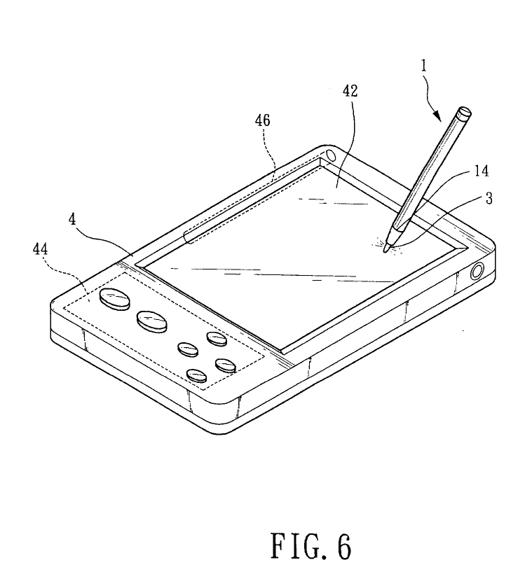

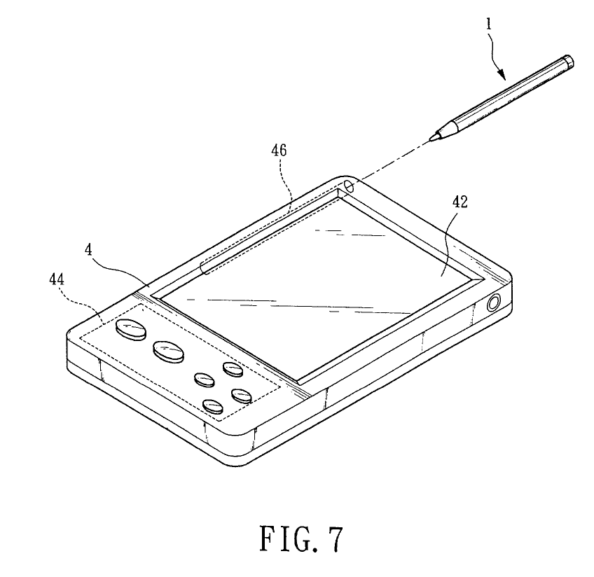

FIG. 6 illustrates how the touch control pen 1 of FIGS. 1 and 2 is used with a PDA 4. The upper surface of the PDA 4 has a touch control screen 42 and a push key zone 44. A groove 46 is cut from an upper side edge of the PDA 4. The touch control pen 1 may be stored in the internal space of the groove 46. During usage, the light emitting diode 3 (which incorporates a stylus or tip) or the stylus 60 touches the touch control screen 42 of the PDA 4 to cause the PDA 4 to execute the programs or instructions selected by the user. In a dark environment, the switch 14 can be turned on to cause the light emitting diode 3 to generate a light source that immediately illuminates the touch control screen 42 of the PDA 4. As a result, the user can still view the touch control screen 42 clearly even if the surrounding environment is dark. FIG. 7 illustrates how the touch control pen 1 can be retained inside the groove 46 for storage, so that the touch control pen 1 can be carried together with the PDA 4.

The present invention also provides a touch control pen for use with a PDA, with the touch control pen having a securing mechanism for securing the touch pen to the housing of the PDA so that the touch control pen does not become dislodged or lost. For example, the touch control pen in FIGS. 2 and 5 can each be provided with a magnetic sleeve 19 and 79, respectively, with the magnetic sleeve 19 and 79 being slid over the outer surface of the pen holder 11 and 70, respectively. The magnetic sleeve 19 and 79 secures the respective touch control pen inside the groove 46 of the PDA 4 because the housing of the PDA 4 is usually made of a metallic material that is attracted by the magnetic forces of the magnetic sleeve 19 and 79 to the touch control pen.

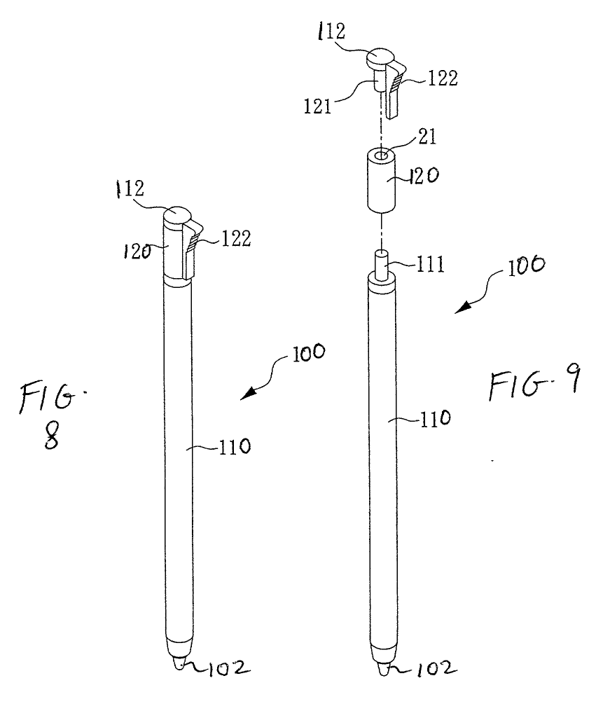

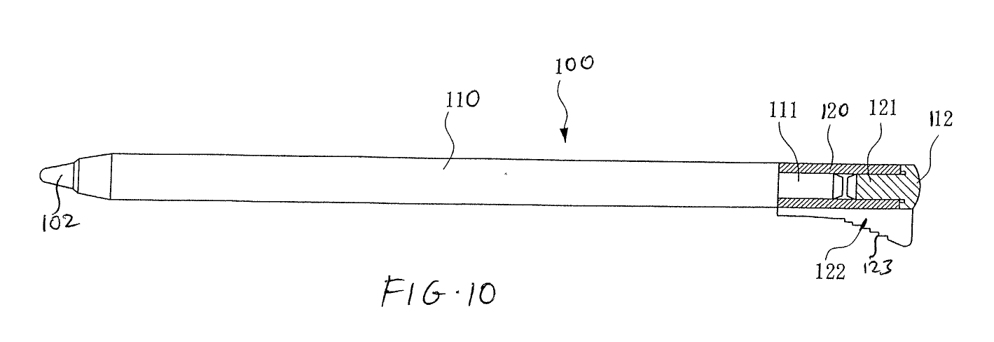

FIGS. 8-10 further illustrate another embodiment of a touch control pen 100 according to the present invention. The pen 100 can incorporate any of the light sources illustrated hereinabove, or can be provided without any light source. The pen 100 has a stylus 102 provided at the forward tip of a pen holder 110. The rear end of the pen holder 110 has a shaft 111 which is retained inside the hollow cylindrical interior of a metallic sleeve 120. A cap piece 112 has a shaft 121 that is also retained inside the interior of the sleeve 120, and the cap piece 112 also has a grip portion 122 that is comprised of an angled toothed surface 123. Thus, the metallic sleeve 120 is secured between the pen holder 110 and the cap piece 112, and performs the same function as the magnetic sleeves 19 and 79 described above in securing the touch control pen 100 inside the groove 46 of the PDA 4. The toothed surface 123 provides the user with a gripping surface for using a finger to push the touch control pen 100 out of the groove 46.

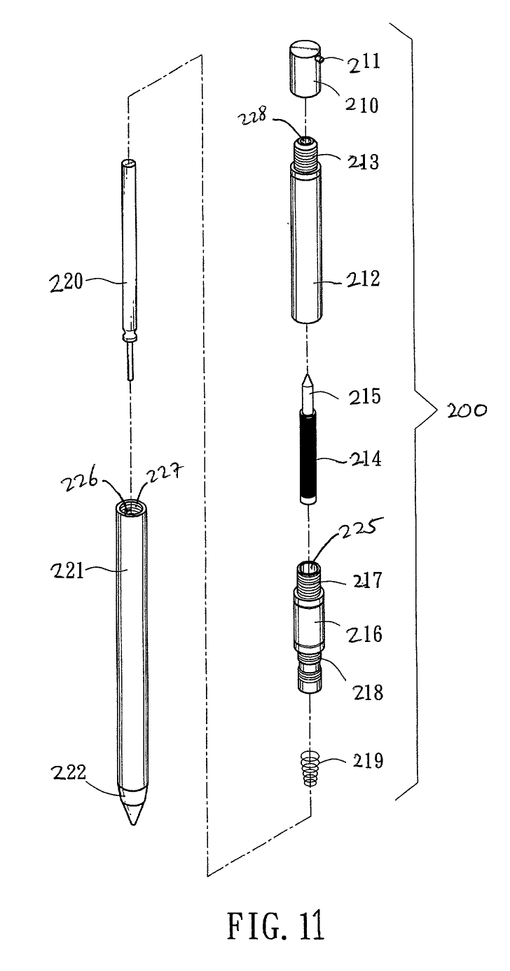

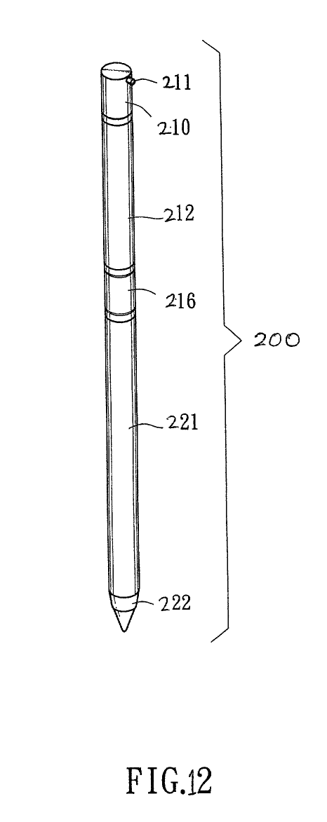

The touch control pens according to the present invention can also incorporate a writing implement. FIGS. 11 and 12 illustrate a touch control pen 200 that incorporates a writing implement 214 in the form of a refill. The touch control pen 200 has a front end that has a first shaft 221 that is similar to the pen holder 11 described above. A light emitting diode (LED) 222 is provided at the forward end of the first shaft 221 in the same manner as described above for the touch control pen 1 in FIGS. 1 and 2. One or more batteries 220 are positioned inside the hollow interior of the first shaft 221, and are electrically coupled to a circuit unit (not shown) and the LED 222 in the same manner as that disclosed above for the touch control pen 1 in FIGS. 1 and 2. A spring 219 biases the battery 220 to be electrically coupled to the circuit unit inside the first shaft 221.

A connector 216 connects the first shaft 221 to a second shaft 212. The connector 216 has a cylindrical bore 225 with an upper tubular portion 217 and a lower tubular portion 218. Each tubular portion 217 and 218 has external threads provided thereon. The lower tubular portion 218 can be threadably coupled to the upper end of the first shaft 221. The first shaft 221 has internal threads 227 provided in its bore 226 at the upper end, with the internal threads 227 adapted to releasably engage the external threads on the lower tubular portion 218. A rotational switch (not shown), which can be the same as the rotational switch disclosed above for the touch control pen 1 in FIGS. 1 and 2, can be provided between the first shaft 221 and the connector 216 so that the first shaft 221 can be rotated with respect to the connector 216 (about the threaded connection at the lower tubular portion 218 with the internal threads 227) to turn the LED 222 ON and OFF. Similarly, the upper tubular portion 217 can be threadably coupled to the lower end of the second shaft 212. The second shaft 212 has internal threads (not shown) provided in its bore at the lower end, with the internal threads adapted to releasably engage the external threads on the upper tubular portion 217.

A writing implement 214, which can be provided in the form of a pen refill that contains ink, is retained inside the cylindrical bore 225 of the connector 216 and the cylindrical bore 228 of the second shaft 212. The implement 214 has a writing tip or stylus 215 that extends through an upper tubular portion 213 of the second shaft 212. A cap 210 has internal threads (not shown) that are adapted to releasably engage the external threads on the tubular portion 213 so as to releasably secure the cap 210 to the top of the second shaft 212. The cap 210 further includes a tappet 211. The user can use his or her finger to push the tappet 211 when the user wishes to push the touch control pen 200 out of the groove 46 of a PDA 4 (see FIG. 6). FIG. 12 illustrates the touch control pen 200 after it has been assembled.

Even though threaded connections are illustrated in FIG. 11 for coupling the first shaft 221, the connector 216, the second shaft 212 and the cap 210, it is also possible to use other mechanisms for coupling these elements, including but not limited to pressing and snap-fit engagements.

The touch control pen 200 can be utilized in the same manner as illustrated in FIGS. 6 and 7 above, with the LED 222 acting as a stylus to touch the touch control screen 42 of the PDA 4 to cause the PDA 4 to execute the programs or instructions selected by the user. In a dark environment, the LED 222 can be turned on to generate a light source that immediately illuminates the touch control screen 42 of the PDA 4. As a result, the user can still view the touch control screen 42 clearly even if the surrounding environment is dark. The touch control pen 200 can also be retained inside the groove 46 for storage, so that the touch control pen 200 can be carried together with the PDA 4. In this regard, the connector 216 can be provided with magnetic material so that the touch control pen 200 can be secured inside the groove 46 of the PDA 4.

In addition to luminating the touch control screen 42 of the PDA 4, the touch control pen 200 can be turned around, and the cap 210 removed, so that the writing tip 215 can be used to write ink messages or notes. Thus, the touch control pen 200 can be used not only to perform all the functions described above for the touch control pens in FIGS. 1, 2, 4, 5 and 8-10, but can also be used for actual writing purposes.

Thus, the touch control pen of the present invention avoids the backing light plate of the prior art (and its wasteful consumption of power) by providing a light source carried on the touch control pen that can be selectively turned on or off by the user, thereby ensuring that the light source is only illuminated when necessary (e.g., in a dark environment). By avoiding the use of a backing light plate, the present invention also simplifies the manufacture and cost of PDAs. In addition, the present invention provides mechanisms to secure the touch control pen inside the housing of the PDA, and can incorporate a writing implement so that the touch control pen can be used for writing purposes.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A touch control pen for a PDA, comprising:
a pen holder having a bore;
a light source coupled to the pen holder for generating light; and
a writing implement retained inside the bore.

2. The apparatus of claim 1, wherein the light source is a light emitting diode.

3. The apparatus of claim 1, wherein the pen holder has a first shaft, a second shaft, and a connector that connects the first shaft and the second shaft, with the first shaft retaining a circuit and at least one battery that is electrically coupled to the circuit, and with the second shaft retaining the writing implement.

4. The apparatus of claim 3, further including a cap that is secured to the second shaft.

5. The apparatus of claim 1, wherein the pen holder has a forward end, and the light source is secured to the forward end of the pen holder.

6. The apparatus of claim 3, wherein the light source is coupled to the circuit.

7. The apparatus of claim 3, further including a switch coupled to the circuit for controlling the turning on and off of the light source.

8. The apparatus of claim 1, further including means for securing the pen holder to a PDA.

9. A PDA assembly, comprising:
a PDA; and
a touch control pen, comprising:
a pen holder having a bore;
a light source coupled to the pen holder for generating light; and
a writing implement retained inside the bore.

10. The assembly of claim 9, wherein the light source is a light emitting diode.

11. The assembly of claim 9, wherein the pen holder has a first shaft, a second shaft, and a connector that connects the first shaft and the second shaft, with the first shaft retaining a circuit and at least one battery that is electrically coupled to the circuit, and with the second shaft retaining the writing implement.

12. The assembly of claim 11, further including a cap that is secured to the second shaft.

13. The assembly of claim 9, wherein the pen holder has a forward end, and the light source is secured to the forward end of the pen holder.

14. The assembly of claim 11, wherein the light source is coupled to the circuit.

15. The assembly of claim 11, further including a switch coupled to the circuit for controlling the turning on and off of the light source.

16. The assembly of claim 9, further including means for securing the pen holder to a PDA.
